(19) United States
(12) Patent Application Publication
(10) Pub. No.: US 2026/0118578 A1
(43) Pub. Date: Apr. 30, 2026

(54) Optical WDM Devices

(71) Applicant: Lightel Technologies, Inc., Renton, WA (US)

(72) Inventors: Shyh-Chung Lin, Renton, WA (US); Xiang Zhang, Renton, WA (US)

(21) Appl. No.: 18/934,142

(22) Filed: Oct. 31, 2024

(51) Int. Cl. G02B 6/12

(52) U.S. Cl. CPC G02B 6/12007; G02B 6/12004; G02B 2006/12102; G02B 2006/12109; G02B 2006/12114; G02B 2006/12164

(57) ABSTRACT

The present invention is generally related to a method of making an optical WDM device. An optical WDM device separates two groups of input wavelengths and directs one group of wavelengths to the transmission port and directs the other group of wavelengths to the reflection port. The present invention uses roof prisms to configure optical paths to improve the isolation performance.

### TECHNICAL FIELD

The present disclosure is generally related to optical communications and, more particularly, to optical wavelength division multiplexing (WDM) devices.

### BACKGROUND

A conventional method of making a fiber optical WDM device uses a filter to separate two groups of input wavelengths, one group of wavelengths passes through the filter, and the other group of wavelengths reflects from the filter. The isolation performance of device is dictated by filter performance. To achieve higher isolation, two filters can stack up in the transmission path to improve the isolation in transmission port. However, this technique is generally not applicable for the reflection port since space is limited in the reflection path. This invention configures optical paths using a roof prism so that an additional filter can be installed in the reflection path to improve the isolation.

### BRIEF DESCRIPTION OF THE DRAWINGS

The accompanying drawings are included to aid further understanding of the present disclosure and are incorporated in and constitute a part of the present disclosure. The drawings illustrate a select number of embodiments of the present disclosure and, together with the detailed description below, explain the principles of the present disclosure. It is appreciated that the drawings are not necessarily to scale, as some components may be shown to be out of proportion to size in actual implementation to clearly illustrate the concept of the present disclosure.

FIG. 1 shows a conventional method of making a fiber optical WDM device where one filter is used to separate transmission wavelengths from the reflection wavelengths. Fiber 101 and fiber 102 are assembled with a dual-fiber collimator 103. A filter 104 is attached to fiber collimator 103. One beam 105 of the first group of wavelengths \1 from fiber 102 reflects from the filter 104, returns to fiber 101. Another beam 106 of the second group of wavelengths λ2 from fiber 102 passes through the filter 104, get collected by fiber 108 through a collimator 107.

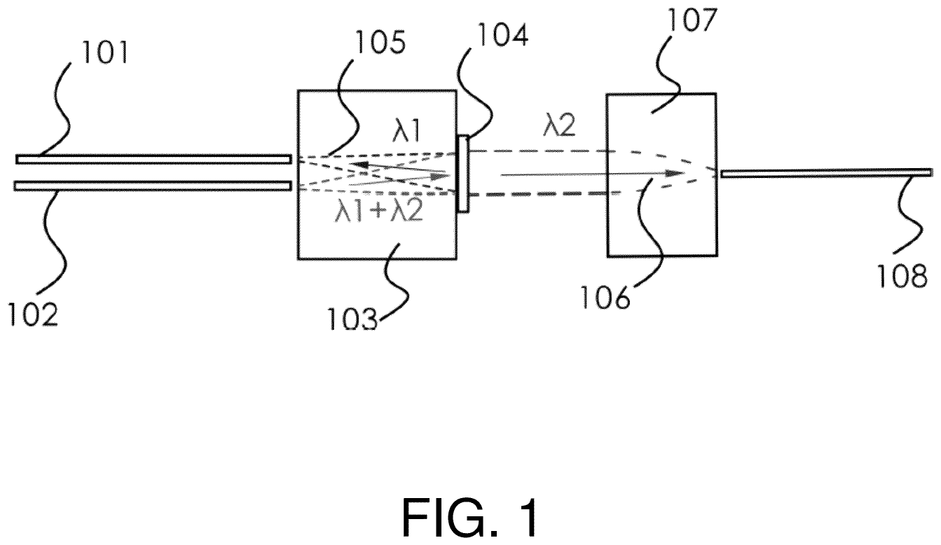

FIG. 2 shows the disclosed method of making a fiber optical WDM device where a roof prism is inserted to configure optical paths, and a first filter is used to separate transmission wavelengths from the reflection wavelengths. A second filter is attached to the flat side of roof prism to improve the isolation performance of the reflected port.

FIG. 3 shows the other disclosed method of making a fiber optical WDM device where a roof prism is inserted to configure optical paths, and a first filter is used to separate transmission wavelengths from the reflection wavelengths. A second filter is attached to the roof side of roof prism to improve the isolation performance of the reflected port.

FIG. 4 shows another disclosed method of making a fiber optical WDM device where a roof prism is inserted to configure optical paths, and a first filter is used to separate transmission wavelengths from the reflection wavelengths. A second filter is attached to the flat side of roof prism and a third filter is attached to the roof side of to improve the isolation performance of the reflected port.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Various implementations of the present disclosure and related inventive concepts are described below. It should be acknowledged, however, that the present disclosure is not limited to any particular manner of implementation, and that the various embodiments discussed explicitly herein are primarily for purposes of illustration. For example, the disclosed method makes fiber optical Polarization Splitter/Combiner devices when WDM filters are replaced by polarization filters, and fibers are replaced by polarization maintaining (PM) fibers.

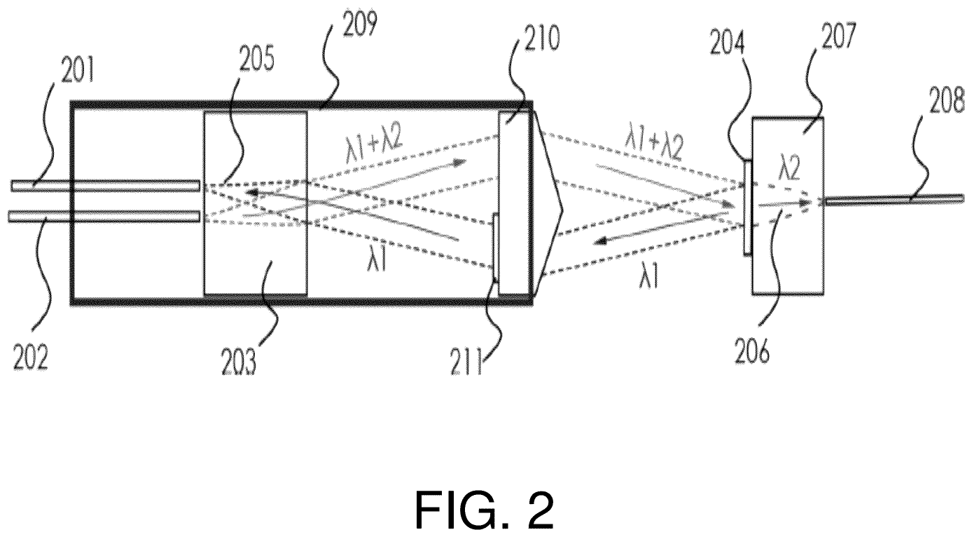

One embodiment of the WDM device is shown in FIG. 2. A first filter 204 is attached to collimator lens 207, and a roof prism 210 is inserted into the optical path. One beam 205 of the first group of wavelengths λ1 from fiber 202 passes through the collimator 203 and the roof prism 210 first, reflects from the first filter 204, then passes through the roof prism 210 and the second filter 211 attached at the flat side of the roof prism 210, before returns to fiber 201 through a collimator lens 203. A glass tube 209 is used to pre-assemble fiber 201, 202 and collimator lens 203 together with roof prism 210 and the second filter 211. Another beam 206 of the second group of wavelengths λ2 from fiber 202 passes through the collimator 203 and the roof prism 210 first, passes through the first filter 204, and gets collected by fiber 208 through a collimator lens 207. Since optical propagation is reciprocal, this WDM device serves both as a wavelength demultiplexer in the above-mentioned direction and serves as a wavelength multiplexer in the reverse direction. The roof prism is made of optically transparent, and isotropic materials such as glasses, crystals including semiconductors.

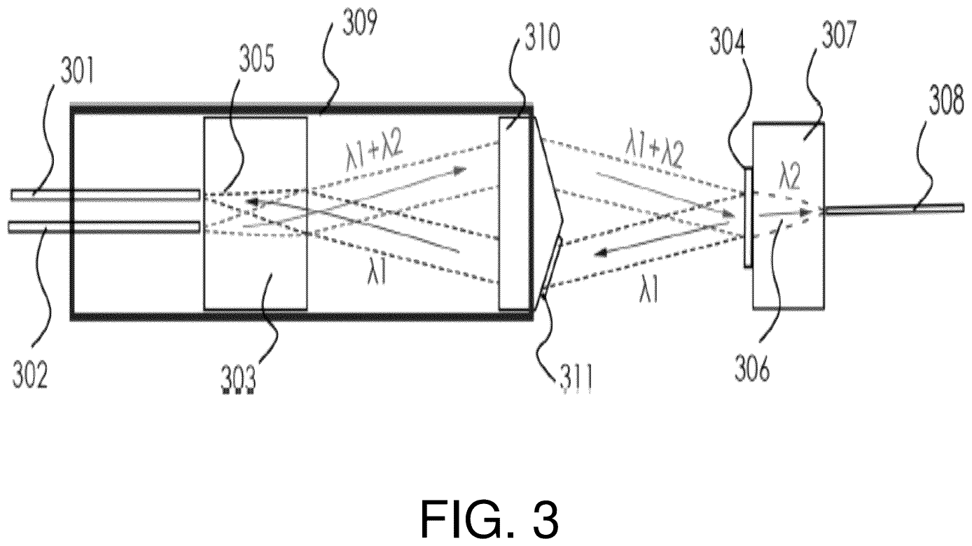

The other embodiment of the WDM device is shown in FIG. 3. A first filter 304 is attached to collimator lens 307, and a roof prism 310 is inserted into the optical path. One beam 305 of the first group of wavelengths λ1 from fiber 302 passes through the collimator 303 and the roof prism 310 first, reflects from the first filter 304, then passes through the second filter 311 attached at the roof side of the roof prism 310 and the roof prism 310, before returns to fiber 301 through a collimator lens 303. A glass tube 309 is used to pre-assemble fiber 301, 302 and collimator lens 303 together with roof prism 310 and the second filter 311. Another beam 306 of the second group of wavelengths λ2 from fiber 302 passes through the collimator 303 and the roof prism 310 first, passes through the first filter 304, and gets collected by fiber 308 through a collimator lens 307. Since optical propagation is reciprocal, this WDM device serves both as a wavelength demultiplexer in the above-mentioned direction and serves as a wavelength multiplexer in the reverse direction. The roof prism is made of optically transparent, and isotropic materials such as glasses, crystals including semiconductors.

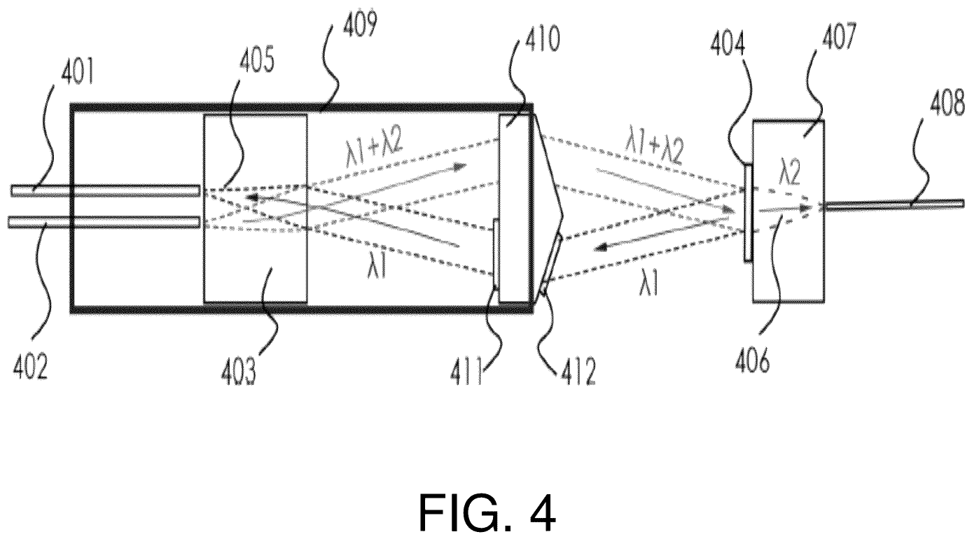

Yet another embodiment of the WDM device is shown in FIG. 4. A first filter 404 is attached to collimator lens 407, and a roof prism 410 is inserted into the optical path. One beam 405 of the first group of wavelengths λ1 from fiber 402 passes through the collimator 403 and the roof prism 410 first, reflects from the first filter 404, then passes through the second filter 412 attached at the roof side of the roof prism 410, the roof prism 410 and a third filter 411 attached at the flat side of the roof prism 410, before returns to fiber 401 through a collimator lens 403. A glass tube 409 is used to pre-assemble fiber 401, 402 and collimator lens 403 together with roof prism 410, a second filter 411 and a third filter 412. Another beam 406 of the second group of wavelengths λ2 from fiber 402 passes through the collimator 403 and the roof prism 410 first, passes through the first filter 404, and gets collected by fiber 408 through a collimator lens 407. Since optical propagation is reciprocal, this WDM device serves both as a wavelength demultiplexer in the above-mentioned direction and serves as a wavelength multiplexer in the reverse direction. The roof prism is made of optically transparent, and isotropic materials such as glasses, crystals including semiconductors.

What is claimed is:

1. A WDM device, comprising:
a dual fiber collimator;
a roof prism;
a first filter;
a second filter; and
a single fiber collimator,
wherein the first filter is attached to the single fiber collimator, and
wherein the second filter is attached to the roof prism.

2. The WDM device of claim 1, wherein the second filter is attached to a flat side of the roof prism.

3. The WDM device of claim 1, wherein the second filter is attached to a roof side of the roof prism.

4. A WDM device, comprising:
a dual fiber collimator;
a roof prism;
a first filter;
a second filter;
a third filter; and
a single fiber collimator,
wherein the first filter is attached to the single fiber collimator, and
wherein the second filter and the third filter are attached to the roof prism.

5. The WDM device of claim 4, wherein the roof prism and the dual fiber collimator are pre-assembled in one sub assembly.

6. The WDM device of claim 4, wherein the roof prism comprises optically transparent glass.

7. The WDM device of claim 4, wherein the roof prism comprises optically transparent isotropic crystals.

8. The WDM device of claim 4, wherein the roof prism comprises optically transparent isotropic semiconductors.

9. A polarization splitter/combiner device, comprising:
a dual PM fiber collimator,
a roof prism;
a first polarization filter,
a second polarization filter, and
a single PM fiber collimator,
wherein the first polarization filter is attached to the single PM fiber collimator, and
wherein the second polarization filter is attached to the roof prism.
